(19) United States
(12) Patent Application Publication
(10) Pub. No.: US 2024/0290180 A1
(43) Pub. Date: Aug. 29, 2024

(54) LOTTERY TICKET SYSTEMS AND METHODS

(71) Applicant: IGT Global Solutions Corporation, Providence, RI (US)

(72) Inventors: Apostolos D. Kallis, Barrington, RI (US); Michael Roeygaard, Rome (IT)

(21) Appl. No.: 18/173,434

(22) Filed: Feb. 23, 2023

(51) Int. Cl. G07F 17/32; G06Q 20/20; G07F 17/42

(52) U.S. Cl. CPC G07F 17/329; G06Q 20/20; G07F 17/3204; G07F 17/3225; G07F 17/42

(57) ABSTRACT

Lottery ticket systems and methods of operation that enable the sequential and simultaneous purchase of lottery tickets via player terminals, a lottery terminal, and associated point-of-sale (POS) system terminals, the printing of such purchased lottery tickets via a lottery ticket printer, and the sequential and simultaneous redemption of winning lottery tickets via such player terminals, lottery terminal, and associated POS system terminals.

### BACKGROUND

The present disclosure relates to lottery ticket systems and methods that enable the purchase and redemption of lottery tickets.

Lottery tickets may be sold in variety of different manners using a variety of different systems such as systems that include lottery terminals. For a draw lottery ticket for a draw lottery game, a player may select the player's numbers or may have the system randomly select the player's numbers (which is often referred to as a quick pick). To purchase a draw lottery ticket in person with player selected numbers, the player fills out a play slip with the player selected numbers and hands that play slip to an operator of a lottery terminal. The operator may use the lottery terminal, or a scanner connected to the lottery terminal to scan the play slip to determine the player's numbers. The lottery terminal may the create a draw lottery ticket including those player numbers and print out the draw lottery ticket. The operator collects the payment for the draw lottery ticket and provides the printed draw lottery ticket to the player. Similarly, to purchase a draw lottery ticket in person using a quick pick feature, the player tells the operator of a lottery terminal how may plays the player wants and the operator enters that number into the lottery terminal. The lottery terminal determines the player's numbers for each play and prints out a draw lottery ticket. The operator collects the payment for the draw lottery ticket and provides the printed draw lottery ticket to the player. These processes can be relatively time consuming. When the top award for a draw lottery game reaches a relatively large amount, there is often an increase in plays of the draw lottery game, and there are often long player lines at locations with such lottery terminals for purchasing such draw lottery tickets in part because the above described processes are relatively time consuming.

### BRIEF SUMMARY

In various embodiments, the present disclosure relates to a lottery ticket system including: a lottery terminal; a first player terminal communicatively connectable to the lottery terminal, the first player terminal configured to obtain first draw game play information from a first player for a first play of a draw lottery game; a second player terminal communicatively connectable to the lottery terminal, the second player terminal configured to obtain second draw game play information from a second player for the first play of the draw lottery game; and a lottery ticket printer communicatively connectable to the lottery terminal, the lottery ticket printer configured to print a first draw lottery ticket for the first player for the first play of the draw lottery game and a second draw lottery ticket for the second player for the first play of the draw lottery game. The lottery terminal, the first player terminal, the second player terminal, and the lottery ticket printer are configured co-act to enable the sequential and simultaneous purchase of the first and second draw lottery tickets by the first and second players.

In various other embodiments, the present disclosure relates to a lottery ticket system including: a lottery terminal; a plurality of player terminals each communicatively connectable to the lottery terminals, each player terminal configured to obtain draw game play information from a player for a play of a draw lottery game; and at least one lottery ticket printer communicatively connectable to the lottery terminal, where the quantity of lottery ticket printers is less than the quantity of player terminals, each lottery ticket printer configured to print draw lottery tickets for the play of the draw lottery game, and wherein the lottery terminal, the player terminals, and each lottery ticket printer are configured co-act to enable the sequential and simultaneous purchase of the multiple draw lottery tickets by multiple players.

In various other embodiments, the present disclosure relates to a lottery ticket system including: a lottery terminal; a first player terminal communicatively connectable to the lottery terminal, the first player terminal configured to obtain first draw game play information from a first player for a first play of a draw lottery game, and to communicate the first draw game information to the lottery terminal to enable the lottery terminal to generate the first draw game lottery ticket; a second player terminal communicatively connectable to the lottery terminal, the second player terminal configured to obtain second draw game play information from a second player for the first play of the draw lottery game, the second player terminal is configured to communicate the second draw game information to the lottery terminal to enable the lottery terminal to generate the second draw game lottery ticket; and a lottery ticket printer communicatively connectable to the lottery terminals, the lottery ticket printer configured to print a first draw lottery ticket for the first player for the first play of the draw lottery game and a second draw lottery ticket for the second player for the first play of the draw lottery game, and the lottery ticket printer configured to cause a first indication that the first draw game lottery ticket is associated with the first player terminal and a second indication that the second draw game lottery ticket is associated with the second player terminal.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a first diagrammatic view of a lottery ticket system including player terminals, a lottery terminal, a lottery ticket printer, and associated POS system terminals in accordance with one example embodiment of the present disclosure.

FIG. 3 is a player side top perspective view of the lottery ticket system of FIG. 2.

FIG. 4 is an operator side top perspective view of the lottery ticket system of FIG. 2.

### DETAILED DESCRIPTION

In various embodiments, the present disclosure relates generally to lottery ticket systems and methods of operating such systems that enable multiple players to sequentially or simultaneously purchase lottery tickets. The lottery ticket systems and methods of the present disclosure can also be configured to enable players to sequentially or simultaneously redeem winning lottery tickets. In various embodiments, the lottery ticket system includes: (a) a lottery terminal, (b) a plurality of player terminals connected to the lottery terminal, and (c) a lottery ticket printer connected to the lottery terminal. In various embodiments, the lottery ticket system is also associated with a point-of-sale system (referred to herein as a POS system) that includes multiple POS system terminals. In various embodiments, the lottery ticket system and method reduces the time for players to purchase lottery tickets, enables the rapid sequential purchase of lottery ticket by multiple players in multiple check-out lanes, and also substantially expands the quantity of lottery tickets that can be generated, printed, and sold at each location where the lottery ticket system is located. In various embodiments, the lottery ticket system and method also reduces the time for players to redeem lottery tickets, enables the rapid sequential redemption of winning lottery ticket by multiple players in multiple check-out lanes, and also substantially expands the quantity of winning lottery tickets that can be redeemed at each location where the lottery ticket system is located.

Draw lottery tickets are employed as example lottery tickets herein to describe the example lottery ticket systems and methods of operation of the present disclosure; however, the present disclosure is not meant to be limited by such examples, and that the lottery ticket systems and methods described herein can be employed for selling and redeeming other types of lottery tickets. For a better understanding of the present disclosure, an example draw lottery ticket is first generally described herein.

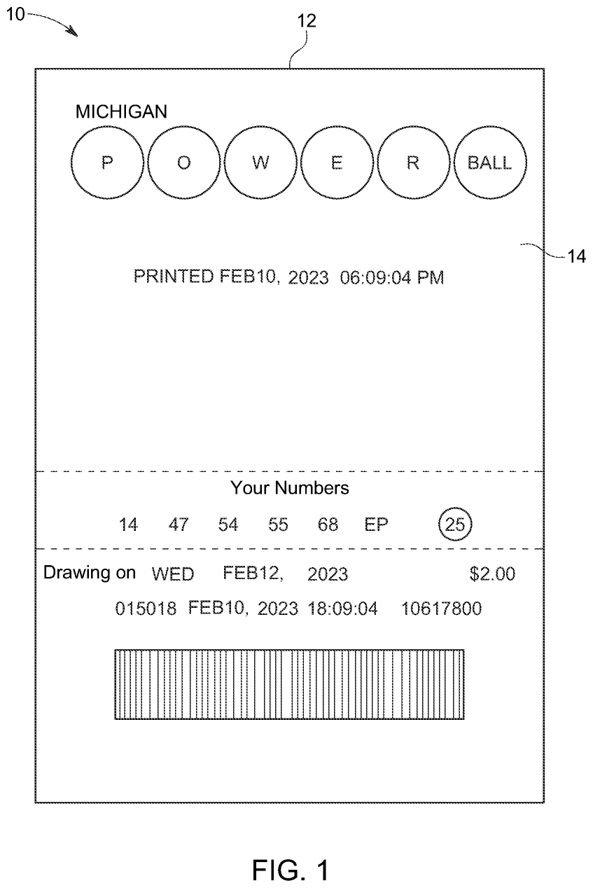

Various known draw lottery tickets are single draw lottery game and single play draw lottery tickets. Draw lottery tickets can either be physical or virtual. An example physical single lottery game single play draw lottery ticket 10 is shown in FIG. 1. This example draw includes: (1) a ticket substrate 12; (2) a front surface 14 of the ticket substrate 12; (3) player numbers printed on the front surface 14 of the ticket substrate 12 for a single play of a single lottery game; (4) a back surface (not shown) of the ticket substrate 12; and (5) lottery game and ticket information (not labeled) printed on the front surface 14 of the ticket substrate 12. This example draw lottery ticket 10 is for a single draw lottery game (scheduled to take place on Wednesday Feb. 12, 2023) and includes a single set of player numbers (i.e., player numbers for a single play of the draw lottery game). It should be appreciated that while this example lottery ticket is for a single play, draw lottery tickets often include multiple sets of player numbers that are for multiple plays of a draw lottery game. The lottery ticket information can include text, one or more ticket numbers, one or more ticket barcodes, and other instant lottery ticket information that is in either or both human readable and machine readable forms. The lottery ticket's barcode is configured to be scanned by a barcode reading device to enable redemption of such draw lottery ticket. As indicated above, various other known draw lottery tickets can be: (1) single lottery game and multiple play draw lottery tickets; (2) multiple lottery game and single play draw lottery tickets; or (3) multiple lottery game and multiple play draw lottery tickets. For simplicity, the present disclosure uses a draw lottery ticket with a single set of player numbers for a single play of a single draw lottery game as an example, but it should be appreciated that the present disclosure can be employed for purchasing and redeeming such various other draw lottery tickets.

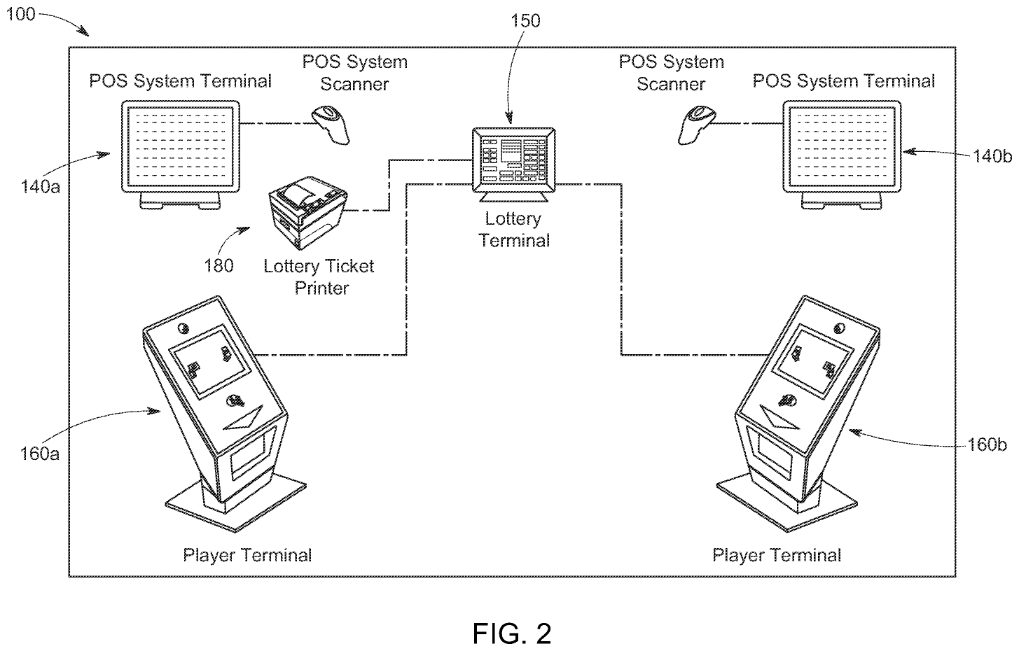

FIGS. 2, 3, and 4 illustrate a lottery ticket system 100 of one example embodiment of the present disclosure. In this example embodiment, the lottery ticket system 100 includes two player terminals 160a and 160b, a single lottery terminal 150, and a single lottery ticket printer 180 that are communicatively connected and configured co-act to enable: (1) the sequential and simultaneous purchase of draw lottery tickets by multiple players and (2) the sequential and simultaneous redemption of winning draw lottery tickets by multiple players. More specifically, the shared lottery ticket printer 180 is communicatively connected to the lottery terminal 150, and the lottery terminal 150 is communicatively connected to the respective player terminals 160a and 160b, as indicated by the dotted communication lines (not labeled). The lottery ticket system 100 is also associated with two POS system terminals 140a and 140b that enable the player payment for the lottery tickets and the payments to players for winning lottery tickets.

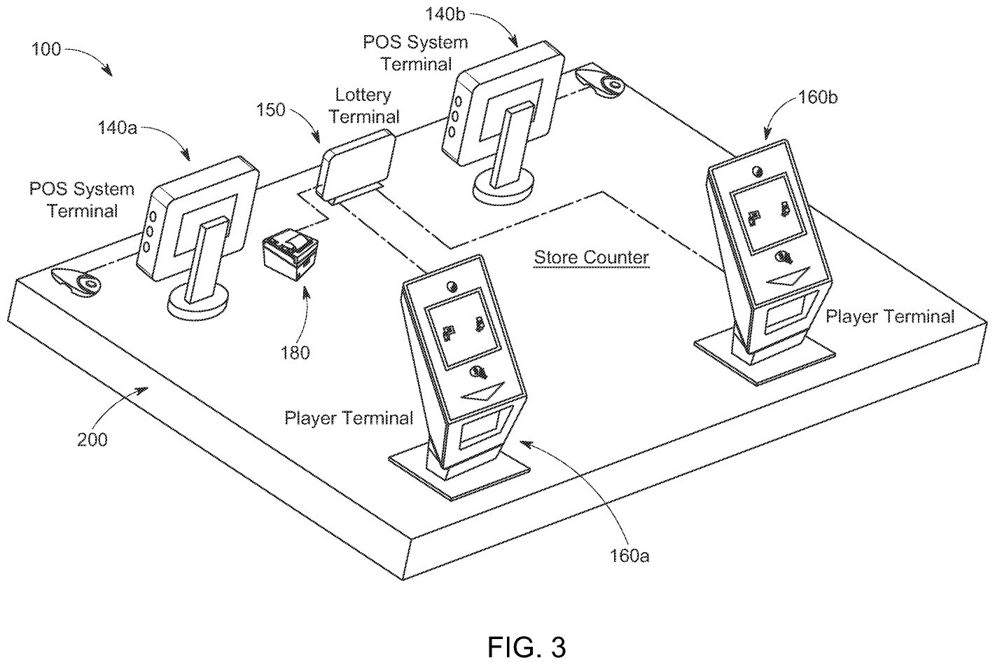

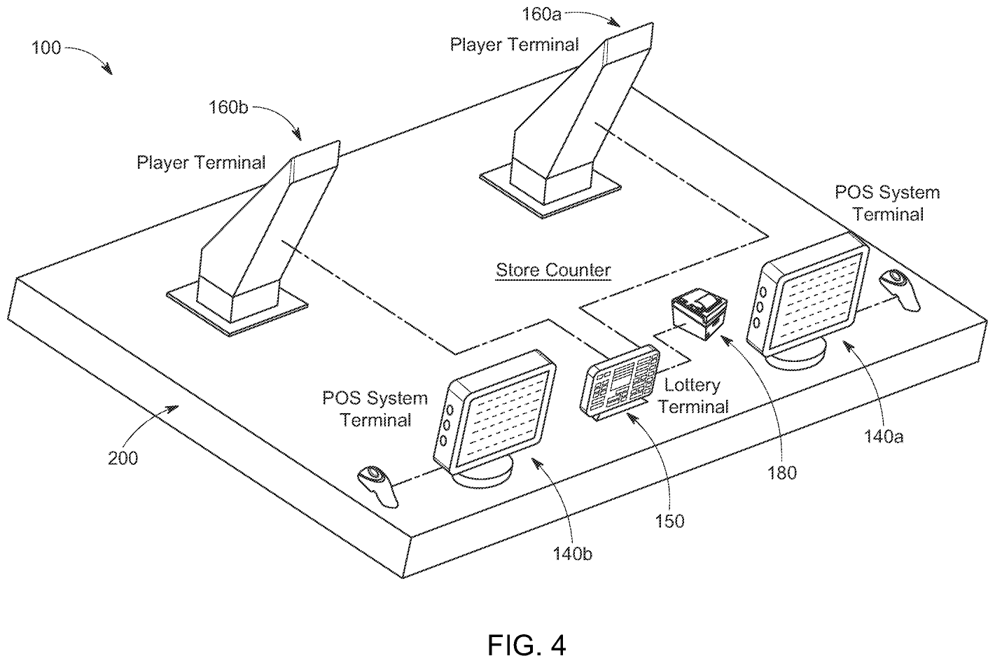

The POS system terminals 140a and 140b, the lottery terminal 150, the player terminals 160a, and 160b, and the lottery ticket printer 180 are configured to be positioned in relatively close proximity to each other such as on a retail store counter 200. The POS system terminals 140a and 140b, the lottery terminal 150, and the lottery ticket printer 180 are configured to be positioned on an operator side of the retail store counter 200 such that they can be simultaneously accessed and used by multiple operators (such as employees of a retail store). The player terminals 160a and 160b are configured to be positioned on an opposite player side of the retail store counter 200 such that they can be simultaneously accessed and used by multiple players. Thus, in this example embodiment, as best shown in FIGS. 3 and 4, the POS system terminals 140a and 140b and the player terminals 160a and 160b face in opposite directions, and the lottery terminal 150 and the player terminals 160a and 160b face in opposite directions.

It should be appreciated that the quantity of POS system terminals, lottery terminal, player terminals, and/or lottery ticket printers can vary (such as being increased) in accordance with the present disclosure. In various embodiments, such as the above-described illustrated embodiment and other embodiments, the quantity of lottery terminals (in this example 1) is less than the quantity of player terminals (in this example 2) to minimize complexity and cost of the lottery ticket system of the present disclosure and of operation thereof. In various embodiments, such as the above-described illustrated embodiment and other embodiments, the quantity of lottery tickets printers (in this example 1) is less than the quantity of player terminals (in this example 2) to minimize complexity and cost of the lottery ticket system of the present disclosure and of operation thereof.

In various embodiments, each of the POS system terminals 140a and 140b are completely separate from the lottery terminal 150 and are part of a POS system such as a retailer or wholesaler POS system that used in facilitating customer purchases of products (besides lottery tickets) in a store such as a retail or wholesale store.

In various embodiments, the lottery terminal 150 is configured to directly communicate via a suitable data network with a lottery central system (not shown) that runs the draw lottery games, stores data regarding purchased draw lottery tickets for each of the draw lottery games, approves, and enables redemption of winning draw lottery tickets, and otherwise facilitates the plays of the draw lottery games.

In various embodiments, the lottery terminal 150 is configured to directly communicate with the lottery ticket printer 180 to cause the lottery ticket printer 180 to print draw lottery tickets determined by the lottery terminal 150. In various embodiments, after the lottery terminal 150 generates a draw lottery ticket, that lottery terminal 150 automatically sends draw lottery ticket information to the lottery ticket printer 180 to cause the lottery ticket printer 180 to print a draw lottery ticket. In various embodiments, lottery terminal 150 includes a print input activatable by the operator of that lottery terminal 150 that, when activated, causes the lottery terminal to send draw lottery ticket information to the lottery ticket printer 180 to cause the lottery ticket printer 180 to print a draw lottery ticket. Such print input can be a physical button of the lottery terminal and/or can be an input displayed by a display device and associated touch screen of the lottery terminal.

In various embodiments, each of the player terminals 160a and 160b is configured to obtain draw game play information (such a quantity of plays of one or more draw games, the player numbers for each play, and/or a quick pick request) provided by the player to that player terminal, and to communicate data for the draw game play to the lottery terminal 150 for one or more plays of the draw lottery game.

In various embodiments, each of the player terminals 160a and 160b is configured to read draw game play information displayed by a player electronic player device (such as an electronic mobile player telephone, tablet, or watch), and to communicate data based on the draw game play information to the lottery terminal 150 for one or more plays of the draw lottery game.

In various embodiments, each of the player terminals 160a and 160b includes a bar code scanner that enables a player to use a player device with one or more barcodes printed thereon or displayed thereon to input the draw game play information (such a quantity of plays of one or more draw games, the player numbers for each play, or a quick pick request), and to communicate data based on such the draw game play information to the lottery terminal 150 for one or more plays of the draw lottery game.

In various embodiments, each of the player terminals 160a and 160b includes a bar code scanner that enables a player to use a player electronic player device (such as an electronic mobile player telephone, tablet, or watch), that has a suitable application downloaded thereon to input the draw game play information (such a quantity of plays of one or more draw games, the player numbers for each play, or a quick pick request), and to communicate data based on such the draw game play information to the lottery terminal 150 for one or more plays of the draw lottery game.

In various embodiments, each of the player terminals 160a and 160b includes a QR code scanner that enables a player to use a player device with one or more QR codes printed thereon or displayed thereby to input the draw game play information (such a quantity of plays of one or more draw games, the player numbers for each play, or a quick pick request), and to communicate data based on such the draw game play information to the lottery terminal 150 for one or more plays of the draw lottery game.

In various embodiments, each of the player terminals 160a and 160b includes a QR code scanner that enables a player to use a player electronic player device (such as an electronic mobile player telephone, tablet, or watch), that has a suitable application downloaded thereon to input the draw game play information (such a quantity of plays of one or more draw games, the player numbers for each play, or a quick pick request), and to communicate data based on such the draw game play information to the lottery terminal 150 for one or more plays of the draw lottery game.

In various embodiments, each of the player terminals 160a and 160b includes a display screen and an associated touch screen that enable a player to select the method of how the player will input play information (such a quantity of plays of one or more draw games, the player numbers for each play, or a quick pick request).

In various embodiments, each of the player terminals 160a and 160b includes a display screen and an associated touch screen that enable a player to input play information (such a quantity of plays of one or more draw games, the player numbers for each play, or a quick pick request), and to communicate data based on such information to the lottery terminal 150 for one or more plays of the draw lottery game.

In various embodiments, each of the player terminals 160a and 160b includes a near field communication (“NFC”) reader that enables a player to use a player electronic player device (such as an electronic mobile player telephone, tablet, or watch), that has a suitable application downloaded thereon to input the draw game play information (such a quantity of plays of one or more draw games, the player numbers for each play, or a quick pick request), and to communicate data based on such the draw game play information to the lottery terminal 150 for one or more plays of the draw lottery game.

In various alternative embodiments, the player terminals can have any suitable combination of the play slip reader, an input display and touch screen input device, a bar code reader, a QR code reader, an NFC reader, and a payment device such as described above to enable the player to enter the draw game play information into such player terminal and/or to purchase a draw lottery game ticket.

For brevity, the example embodiment described below of the player terminals 160a and 160b have bar code readers and are configured to enable the player to display a barcode on the player's electronic mobile device to provide the appropriate draw game play information (such a quantity of plays of one or more draw games, the player numbers for each play, or a quick pick request) and read such bar codes to obtain the draw game play information. This is not meant to limit the present disclosure.

In various embodiments, the lottery ticket system 100 is configured to provide one or more indicators that are configured to cause an indication of, for each printed draw lottery ticket, which of the player terminals 160a or 160b caused that draw lottery ticket to be printed. This enables the operators of the POS system terminals 140a and 140b to provide the correct printed draw lottery tickets to the respective players at the player terminals 160a and 160b that purchased those respective draw lottery tickets. In various different embodiments, the indicator(s) can be provided by the lottery terminal 150, the lottery ticket printer 180, or on the printed lottery tickets, or can be an additional separate device in accordance with the present disclosure. For example, in various embodiments, as further discussed below, the lottery ticket printer 180 can cause an indication of, for each printed draw lottery ticket, which the player terminal caused that draw lottery ticket to be printed. This enables the operators of the POS system terminals 140a and 140b, for each printed draw lottery ticket, to see this indication when removing that printed draw lottery ticket from the printer 180 and to provide that printed draw lottery ticket to the appropriate player that purchased that draw lottery ticket. In various embodiments, the lottery terminal 150 sends a player terminal identifier along with or as part of the draw lottery ticket information to the lottery ticket printer 180 such that the lottery ticket printer 180 can cause an indication of which player terminal 160a or 160b the draw lottery ticket being printed is associated with. In various embodiments, as further described below, the lottery ticket printer 180 can print such a suitable indication of on each draw lottery ticket itself. This indication informs the operators of the POS system terminals 140a and 140b of which player to provide the printed lottery ticket to as further discussed below.

In various alternative embodiments, the POS system terminals 140a and 140b includes one or more suitable devices for obtaining payment from the respective players for the purchases of the draw lottery ticket. For example, the POS system terminals 140a and 140b can include conventional currency receipt devices, credit card or debit card reading devices, other cashless payment devices. In various embodiments, the payment for the purchased lottery ticket are thus by the conventional POS system terminals 140a and 140b for the respective player terminals 160a and 160b. In other words, a first operator at POS system terminal 140a collects payment for lottery ticket purchases via player terminal 160a, and a second operator at POS system terminal 140b collects payment for lottery ticket purchases via player terminal 160b. This enables the simultaneous, substantial simultaneous, or rapid sequential purchases of lottery tickets in multiple lanes, which only employing one lottery terminal and one lottery ticket printer.

In various alternative embodiments, each of the player terminals 160a and 160b include one or more suitable devices for obtaining payment from the player for the purchase of the draw lottery tickets such as from a lottery eWallet as payment system (wherein the lottery eWallet payment system can be funded by debit and credit card payments in the background).

Various example methods of operation for this example embodiment are now described.

In one example, a player uses an application on the player's electronic mobile device to enter the draw game play information (such as player numbers for a selected play of a selected draw game). After a player approaches the player terminal 160a and positions the player electronic mobile device in a location that enables the player terminal 160a to scan a bar code displayed by the player electronic mobile device, the player terminal 160a reads the bar code to obtain the draw game play information for the selected play of the selected drawing game by the player. Responsive to obtaining the draw game play information, the player terminal 160a creates in real time draw game play request data based on draw game play information. This draw game play request data can simply be the information read by the player terminal 160a or can be suitably enhanced or interpreted information. The player terminal 160a transmits via its data transmitter (and via a suitable communication line) in real time the draw game play data to the lottery terminal 150.

Responsive to receipt of this draw game play request data by the lottery terminal 150 from the player terminal 160a, the lottery terminal 150 processes the draw game play request data and creates in real time draw game play response data. In various embodiments, the draw game play response data can either include an approval or a denial. When approved, the draw game play response data can also include the draw game play lottery ticket information such as discussed below.

Responsive to the draw game play response data including the denial, the lottery terminal 150 transmits (via the communication line) in real time the draw game play response data to the player terminal 160a to enable the player terminal 160a to indicate (such as by displaying an indication of) that the requested purchase of the requested draw game lottery ticket was denied (and possibly the reason for the denial). A request may be denied, for example, if there is an error with the barcode. In such case, the lottery terminal 150 does not generate the draw lottery ticket for the player.

Responsive to the draw game wager response data including the approval, the lottery terminal 150 can function in a conventional manner or another suitable manner to determine the draw lottery ticket for the player based on the draw game play request data. This can include any suitable communications with a lottery central system regarding the creation of the draw lottery ticket and the storage of respective necessary information regarding the draw lottery ticket by the lottery central system. In various embodiments, the lottery terminal 150 can require the operator to make a suitable input that causes the lottery ticket printer 180 to print the lottery ticket. In such embodiments, after receiving such input, the lottery terminal 150 also causes the lottery ticket printer 180 to print the draw lottery ticket by sending a lottery ticket print request to the lottery ticket printer 180. The lottery ticket print request includes all of the data that the lottery ticket printer 180 needs to print the lottery ticket and can include an identification of the player terminal 160a that initiated such request. In various other embodiments, the lottery terminal 150 can automatically cause the lottery ticket printer 180 to print the draw lottery ticket by sending a lottery ticket print request to the lottery ticket printer 180. That lottery ticket print request includes all of the data that the lottery ticket printer 180 needs to print the lottery ticket and can include an identification of the player terminal 160a that initiated such request.

Responsive to receiving the lottery ticket print request from the lottery terminal 150, the lottery ticket printer 180 uses the lottery ticket print request to print the draw lottery ticket. As mentioned above, in various embodiments, the lottery ticket printer 180 causes an indication of the player terminal 160a that initiated the request for the printed draw lottery ticket. In other words, the lottery ticket printer 180 can indicate that the printed draw lottery ticket is associated with the respective one of the player terminals 160a or 160b. As mentioned above, this can be done in any suitable manner such as via printing an indication of the respective player terminal on the lottery ticket (and/or in other alternative embodiments a display or one or more other visual indicators by the lottery ticket printer 180). The operator can see such indication, can collect payment from the respective player at the respective player terminal 160a, obtain the respective printed lottery ticket from the lottery ticket printer 180, and provide the printed lottery ticket to the respective player at the respective player terminal 160a. Thus, the lottery ticket system of the present disclosure facilitates the delivery of the printed lottery ticket to the correct player even though multiple player terminals are associated with a single lottery terminal and a single lottery ticket printer.

In various alternative embodiments, the lottery terminal 150 or the shared lottery ticket printer 180 can suitably indicate which of the player terminals 160a and 160b that each printed lottery ticket is for. For example, in various embodiments, the lottery terminal or the shared lottery ticket printer 180 can display a light, an arrow, or other suitable indicator for each printed lottery ticket as to which player terminals 160a or 160b that each printed lottery ticket is for.

In various embodiments, the lottery terminal 150 operates automatically as described above such that the operator does not need to perform any functions other than collecting the payment from the player using one of the POS system terminals and providing the respective player the respective printed draw lottery ticket.

In various embodiments, the lottery terminal 150 operates automatically as described above except that the operator needs to review the draw lottery ticket purchase information displayed by the lottery terminal 150 and make an input or approve (or deny such purchase). In various embodiments, this approval input also causes the lottery ticket to be printed by the lottery ticket printer 180. In various embodiments, the lottery terminal 150 operates automatically as described above except that the operator needs to make the input (such as described above) to cause the lottery ticket to be printed by the lottery ticket printer 180.

In various embodiments, the player terminal 160b and the lottery terminal 150 operate in the same manner for draw lottery ticket purchases as the player terminal 160a and the lottery terminal 150 (and thus such operation is not described herein for brevity).

The lottery ticket system 100 and methods of operating the system of the present disclosure also take into account when the player terminals 160a and 160b are used simultaneously or substantially simultaneously, and when the player terminals 160a and 160b are used rapidly sequentially.

In various embodiments, the lottery terminal 150 manages the situations when the player terminals 160a and 160b are used simultaneously or substantially simultaneously, and when the player terminals 160a and 160b are used rapidly sequentially. In various alternative embodiments, the lottery ticket system 100 includes a suitable session manager (not shown). In various embodiments, the session manager is built into the lottery terminal 150. In various embodiments, the session manager manages the situations when the player terminals 160a and 160b are used simultaneously or substantially simultaneously, and when the player terminals 160a and 160b are used rapidly sequentially.

In various embodiments, the lottery ticket system 100, such as via the lottery terminal 150 itself or via a session manager, controls when the lottery terminal 150 sends or can send lottery ticket print requests to the lottery ticket printer 180 to control the printing of the draw lottery tickets for different players. For example, based on a que maintained by the lottery terminal 150 itself or the session manager, the lottery terminal 150 can alternatively send lottery ticket print requests to the lottery ticket printer 180. These alternative print requests can be time based or based on any suitable determinations. For instance, at any one point in time, the lottery terminal 160 can send a first lottery ticket print request for a lottery ticket in a que to the lottery ticket printer 180 and hold a second lottery ticket print request for another lottery ticket in the que.

In various other embodiments, the lottery terminal 150 itself or the session manager can control the purchase and printing of lottery tickets by locking and unlocking the respective player terminals 160a and 160b or by activating or deactivating the respective player terminals 160a and 160b. In various such embodiments, the respective player terminals 160a and 160b can indicate, such as by a suitable display on the display device of the player terminal, the status of such player terminal.

In various embodiments, the lottery terminal 150 itself or the session manager ensures that no new player request can be processed until the current player request in process has completed. Requests from the player terminals 160a and 160b can thus be queued in the lottery terminal 150 itself or the session manager and will have a configurable time-out to report back to the requesting player terminal 160a or 160b with suitable status and error code(s).

In various embodiments, the lottery terminal 150 does not include any lottery ticket removal sensors or any session managers, and simply causes the lottery ticket printer 180 to print lottery tickets in the order received by the lottery terminal 150. In such embodiments, because each lottery ticket is clearly marked which an indication of which player terminal it is associated with, the operators will be able to easily identify which lottery tickets go to which players even if multiple printed lottery tickets are stacked on the lottery ticket printer 180.

In various alternative embodiments, the shared lottery ticket printer 180 does not print the next lottery ticket until the previous printed lottery ticket is removed from the lottery ticket printer 180. In various such embodiments, the lottery ticket printer 180 can include a suitable sensor to detect when printed lottery tickets are removed from the lottery ticket printer 180.

In various embodiments, the player terminals 160a and 160b are also configured to facilitate redemption of winning draw lottery tickets for winning amounts under a limit (such as $600), and in various embodiments, the player terminals 160a and 160b are also configured to facilitate redemption of winning instant lottery tickets for winning amounts under a limit (such as $600).

In various such embodiments, each of the player terminals 160a and 160b includes a reader such as a barcode reader configured to read the bar code on a lottery ticket. In one example, after a player approaches the player terminal 160a and positions a lottery ticket in a location that enables the player terminal 160a to read the bar code of the lottery ticket, the player terminal 160a reads the bar code of the draw lottery ticket to obtain the lottery ticket information. Responsive to obtaining the lottery ticket information, the player terminal 160a creates in real time lottery ticket redemption request data based on lottery ticket information. This lottery ticket redemption request data can simply be the information read by the player terminal 160a or can be suitably enhanced or interpreted information. The player terminal 160a transmits via its data transmitter (and via a suitable communication line) in real time the lottery ticket redemption request data to the lottery terminal 150. Responsive to receipt of this lottery ticket redemption request data by the lottery terminal 150 from the player terminal 160a, the lottery terminal 150 processes the lottery ticket redemption request data. In alternative embodiments, the player terminal 160a simply transmits lottery ticket information to the lottery terminal 160a and the lottery terminal 160a creates the lottery ticket redemption request.

In various embodiments, the lottery terminal 150 can require the operator to make one or more inputs for a redemption to be sent to the lottery central system for approval and for the eventual payout. One of the required inputs by the operator can be a confirmation that the operator can pay out a win before validation is completed on the lottery system and before the payout confirmation is displayed to the player.

The lottery terminal 150 can function in a conventional manner or another suitable manner to approve or deny the lottery ticket redemption request. This can include any suitable communications with the lottery central system regarding the lottery ticket redemption request. The lottery central system can either verify or not verify that the lottery ticket is a winning lottery ticket that has not been previously redeemed, the amount of the win, and whether the winning amount is under the limit. More specifically, for example, the lottery central system processes the lottery ticket redemption request data and creates in real time ticket redemption response data. The lottery central system verifies the status and award amount of the winning lottery ticket and provides the relevant response as well as updates the status of the lottery ticket in its database(s). The ticket redemption response data can include data relating to the lottery ticket indicating that the lottery ticket is in one of the following categories: (1) no win, (2) low-tier win amount, (3) mid-tier win amount, and (4) high-tier win amount. The ticket redemption response data can include for each of the low-tier win amount and the mid-tier win amount, a respective amount to be paid to the player via the respective POS system terminal. The ticket redemption response data can include for the high tier win amount (over the limit) an amount won by the player, and that the player must seek payment in an alternative manner from the lottery system. This can be performed in different manners in accordance with the present disclosure.

Responsive to the lottery central system not verifying the lottery ticket, the lottery central system sends a denial to the lottery terminal 150 and the lottery terminal 150 creates and sends the respective player terminal 160a lottery ticket redemption request denial data that enables the player terminal 160a to display an indication of the redemption denial to the player and the reason for the denial.

Responsive to the lottery central system verifying the lottery ticket as a winning draw lottery ticket, the lottery central system creates and sends an approval to the lottery terminal 150. The lottery terminal 150 uses that approval to display on a display device of the lottery terminal 150 to enable the operator to see the amount won by the player that the operator should pay to the player for that winning draw game lottery ticket via the respective POS system terminal 140a. The lottery terminal 150 can also display a suitable indication for each respective payout on respective the player terminal that the payout is associated with to ensure that the appropriate player received the respective payout. The lottery terminal 150 can require the operator to make a suitable input to confirm that the winning amount is paid to the player. In various embodiments, the lottery or the POS system terminal can print any suitable receipts for such payouts or payments. In various embodiments, the lottery system 100 enables a player to re-invest winning amount by placing an order for additional draw tickets using any of the previous described methods at the same player terminal.

In various embodiments, the player terminal 160b and the lottery terminal 150 operate in the same manner for lottery ticket redemptions as the player terminal 160a and the lottery terminal 150 (and thus such operation is not described herein for brevity).

These various example embodiments of the present disclosure provide a series of advantages that enable lottery tickets to be purchased and redeemed. The advantages include but are not limited to the following advantages: (a) providing multiple player terminals, a single lottery terminals, and a single lottery ticket printer that enables the sequential and simultaneous purchase and redemption of lottery tickets by multiple players; (b) providing easy installation of such devices; (c) not requiring substantial changes to how operators use such devices or collect payments from players; (d) providing such devices with limited required additional training by operators in such facilities to use such devices; and (e) maintaining security needs for lottery systems and/or the retailer's own network(s).

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery ticket system comprising:
a lottery terminal;
a first player terminal communicatively connectable to the lottery terminal, the first player terminal configured to obtain first draw game play information from a first player for a first play of a draw lottery game;
a second player terminal communicatively connectable to the lottery terminal, the second player terminal configured to obtain second draw game play information from a second player for the first play of the draw lottery game; and
a lottery ticket printer communicatively connectable to the lottery terminal, the lottery ticket printer configured to print a first draw lottery ticket for the first player for the first play of the draw lottery game and a second draw lottery ticket for the second player for the first play of the draw lottery game,
wherein the lottery terminal, the first player terminal, the second player terminal, and the lottery ticket printer are configured co-act to enable the sequential and simultaneous purchase of the first and second draw lottery tickets by the first and second players.

2. The lottery ticket system of claim 1, wherein the lottery terminal, the first player terminal, the second player terminal, and the lottery ticket printer are configured to be associated with first and second POS system terminals that respectively enable payments for such first and second draw lottery tickets by the first and second players.

3. The lottery ticket system of claim 2, wherein the first and second POS system terminals are part of a POS system that enables purchases of products other than lottery tickets.

4. The lottery ticket system of claim 1, wherein the lottery terminal is configured to directly communicate via a data network with a lottery central system.

5. The lottery ticket system of claim 1, wherein
the first player terminal is configured to obtain the first draw game information and to communicate the first draw game information to the lottery terminal to enable the lottery terminal to generate the first draw game lottery ticket, and
the second player terminal is configured to simultaneously obtain the second draw game information and to communicate the second draw game information to the lottery terminal to enable the lottery terminal to generate the second draw game lottery ticket.

6. The lottery ticket system of claim 5, wherein the lottery terminal is configured to determine an order that first draw game lottery ticket and the second draw game lottery ticket are printed by the lottery ticket printer.

7. The lottery ticket system of claim 6, which is configured to cause a first indication that the first draw game lottery ticket is associated with the first player terminal and a second indication that the second draw game lottery ticket is associated with the second player terminal.

8. The lottery ticket system of claim 7, where the lottery ticket printer is configured to print one of the first indication on the first draw lottery ticket and the second indication on the second draw lottery ticket.

9. The lottery ticket system of claim 7, where the lottery ticket printer is configured to display the first indication and the second indication.

10. The lottery ticket system of claim 7, where the lottery terminal is configured to display the first indication and configured to display the second indication.

11. The lottery ticket system of claim 1, wherein each of the player terminals are configured to obtain draw game play information from an electronic player device.

12. The lottery ticket system of claim 1, wherein each of the first and second player terminals comprises one of: a bar code scanner, a QR code scanner, and a near field communication reader.

13. A lottery ticket system comprising:
a lottery terminal;
a plurality of player terminals each communicatively connectable to the lottery terminals, each player terminal configured to obtain draw game play information from a player for a play of a draw lottery game; and
at least one lottery ticket printer communicatively connectable to the lottery terminal, where the quantity of lottery ticket printers is less than the quantity of player terminals, each lottery ticket printer configured to print draw lottery tickets for the play of the draw lottery game,
wherein the lottery terminal, the player terminals, and each lottery ticket printer are configured co-act to enable the sequential and simultaneous purchase of the multiple draw lottery tickets by multiple players.

14. The lottery ticket system of claim 13, wherein the lottery terminal, the player terminals, and the lottery ticket printer are configured to be associated with a plurality of POS system terminals that respectively enable payments for such draw lottery tickets.

15. The lottery ticket system of claim 13, wherein the player terminals are configured to simultaneously obtain the draw game information from multiple players and to simultaneously communicate the draw game information to the lottery terminal, the lottery terminal is configured to simultaneously generate multiple draw game lottery tickets, and the lottery ticket printer(s) is/are configured to print the multiple draw game lottery tickets in an order determined by the lottery terminal, and which is configured to cause indications of which draw game lottery tickets are associated with which of the player terminals.

16. The lottery ticket system of claim 15, where the lottery ticket printer(s) is/are configured to print the indications on the lottery tickets.

17. The lottery ticket system of claim 15, where the lottery terminal is configured to display the indications.

18. A lottery ticket system comprising:
a lottery terminal;
a first player terminal communicatively connectable to the lottery terminal, the first player terminal configured to obtain first draw game play information from a first player for a first play of a draw lottery game, and to communicate the first draw game information to the lottery terminal to enable the lottery terminal to generate the first draw game lottery ticket;
a second player terminal communicatively connectable to the lottery terminal, the second player terminal configured to obtain second draw game play information from a second player for the first play of the draw lottery game, the second player terminal is configured to communicate the second draw game information to the lottery terminal to enable the lottery terminal to generate the second draw game lottery ticket; and
a lottery ticket printer communicatively connectable to the lottery terminals, the lottery ticket printer configured to print a first draw lottery ticket for the first player for the first play of the draw lottery game and a second draw lottery ticket for the second player for the first play of the draw lottery game, and the lottery ticket printer configured to cause a first indication that the first draw game lottery ticket is associated with the first player terminal and a second indication that the second draw game lottery ticket is associated with the second player terminal.

19. The lottery ticket system of claim 18, where the lottery ticket printer is configured to print the first indication and the second indication.

20. The lottery ticket system of claim 18, where the lottery terminal is configured to display the first indication and configured to display the second indication.
